(19) United States
(12) Patent Application Publication
(10) Pub. No.: US 2008/0165820 A1
(43) Pub. Date: Jul. 10, 2008

(54) Method and apparatus for producing grating, and DFB solid-state dye laser based on the grating

(75) Inventor: Makoto Fukuda, Chitose-shi (JP)

Correspondence Address: OLIFF & BERRIDGE, PLC, P.O. BOX 320850, ALEXANDRIA, VA, 22320-4850, US

(73) Assignee: MINEBEA CO., LTD., Kitasaku-Gun (JP)

(21) Appl. No.: 11/987,973

(22) Filed: Dec. 6, 2007

(30) Foreign Application Priority Data
Dec. 7, 2006 (JP) 2006-330561

(51) Int. Cl. H01S 3/123; B29D 11/02; G03B 27/70

(52) U.S. Cl. 372/53; 216/24; 355/66

(57) ABSTRACT

To provide a DFB solid-state dye laser including a grating having Moire interference fringes. A DFB solid-state dye laser element includes: a laser medium containing an organic dye; and a distribution feedback type resonance unit having a third grating including a Moire fringe corresponding to an overlap between a first grating and a second grating formed in different directions. The third grating including a Moire fringe is formed by irradiating a photoresist with a laser for two-beam interference exposure, and then rotating a substrate by a predetermined angle and re-irradiating the substrate with the laser.

### BACKGROUND OF THE INVENTION

1. Field of the Invention

The present invention relates to a method of producing a grating (diffraction grating). In particular, the invention relates to method and apparatus for producing a diffraction grating with a Moire fringe, and to a DFB solid-state dye laser based on the grating.

2. Description of the Related Art

Hitherto, DFB lasers have been known, which realize a sharp-pointed oscillation spectrum using a DFB (distributed feedback) structure composed of gratings formed in an element. Among such lasers, a DFB solid-state dye laser that has a laser medium prepared by doping an organic dye into a solid material such as plastic, has been expected to be applicable in various fields because of various advantages such as its small size, its high handleability, and its low manufacturing cost.

In general DFB lasers, a grating needs to be formed with high accuracy in order to realize excellent laser characteristics. As a method of forming the high-accuracy grating, an active layer is etched using a photoresist mask formed in a grid pattern with a two-beam interference exposure process (see Japanese Unexamined Patent Application Publication No. Hei 6-300909, for example).

With regard to the method of forming a grating, the inventor of the present invention has already proposed an “etchless” process for producing a DFB solid-state dye laser that omits etching after a step of patterning a photoresist with the two-beam interference exposure process (see M. Fukuda and K. Mito, Jpn. J. Appl. Phys. Vol. 42 (2003), pp. L1282-L1284, for example).

First, as shown in FIG. 11A, a photoresist (TSMR-V90 available from TOKYO OHKA KOGYO Co., Ltd., for instance) is applied onto the surface of a substrate made of glass or the like through spin coating, followed by pre-baking. Next, as shown in FIG. 11B, the two-beam interference exposure process is performed using a laser beam (for example, Ar ion laser or He—Cd laser) to record light and dark patterns of an interference fringe onto a photoresist film. After that, as shown in FIG. 11C, the substrate is rinsed or post-baked to produce a grating to which stripe patterns corresponding to the light and dark patterns of the interference fringe are transferred as a physically uneven structure (Λ represents a grating period). Subsequently, as shown in FIG. 11D, an organic-dye-doped solid material (for example, acrylic or silica glass) is applied as a laser medium onto the surface of the photoresist-based grating to thereby manufacture a DFB solid-state dye laser. In the DFB solid-state dye laser, as shown in FIG. 11E, irradiation with excitation light (for example, second harmonics of an Nd:YAG laser) triggers oscillation of the DFB solid-state dye laser and thus, laser light having a small spectrum bandwidth is output.

To describe an appropriate condition for the two-beam interference exposure process of FIG. 11B, a mirror 1003 (for example, aluminum mirror) is used with its reflection surface set at right angles to the surface of a substrate 1001 on which a photoresist 1002 is deposited, as shown in FIG. 12A. According to this layout, an incident beam L from a laser light source (not shown) is divided into a beam that directly enters the substrate 1001 (an optical path thereof is denoted by L_{D}, for example) and a beam that is reflected by the mirror 1003 and then enters the substrate 1001 (an optical path thereof is denoted by L_{R}, for example), and the photoresist 1002 is periodically exposed to an interference fringe resulting from interference between the two beams. A resultant grating period Λ (FIG. 1C) is given by the following expression:

Λ=λ/(2 sin θ) (1)

where λ represents a wavelength of the incident beam L and θ represents an incident angle thereof.

This process utilizes stripe patterns formed on the photoresist with the two-beam interference exposure process as a structure forming the grating (hereinafter referred to as “photoresist grating”), and thus omits a subsequent etching step. Hence, this process reduces a processing time and an environmental load.

The inventor of the present invention has succeeded in realizing laser oscillation in a visible light range (590 nm to 630 nm in terms of wavelength of output laser light) under satisfactory conditions (see M. Fukuda and K. Mito, Jpn. J. Appl. Phys. Vol. 42 (2003), pp. L1282-L1284). Further, the inventor has successfully produced a two-dimensional grating on the basis of the etchless process and observed oscillation of two laser beams of different wavelengths (see NAKAI Naoya, FUKUDA Makoto, and MITO Keiichi, “Oscillation characteristics of DFB solid-state dye laser”, the Proceedings of the joint symposium of the 40th Applied Physics Hokkaido chapter and the 1st OSJ Hokkaido chapter, C-21, the Chitose Institute of Science and Technology, Oct. 16 and 17, 2005).

Currently, there is a demand to increase the oscillation wavelength band of a DFB solid-state dye laser up to a near-infrared region so as to apply the laser to a light source for optical communications in the near-infrared wavelength (1.3 to 1.5 μm) region, for example.

To elongate an oscillation wavelength of the DFB solid-state dye laser in this way, it is necessary to use an organic dye having an appropriate fluorescence spectrum and to form a grating with a longer grating period. However, it is difficult to realize a long grating period with the two-beam interference exposure process as shown in FIGS. 12A and 12B for the following reasons.

That is, a spatial period Λ of an interference fringe resulting from interference of two beams (that is, a period of grating including the fringe) is derived from Expression (1). Since the wavelength λ of applied laser light is fixed, so the incident angle θ needs to be decreased in order to produce an interference fringe with a long period Λ. In addition, since two laser beams are generated with the same beam width and the same mirror size, the two beams are superimposed. As a result, an available region of the interference fringe is reduced down to a region B of FIG. 12B from a region A of FIG. 12A, which hinders formation of a grating having a large area. As a conceivable measure for increasing the interference fringe period Λ, the wavelength λ of applied laser light may be increased. In general, however, photoresists have sensitivity to light in a UV region and, a short-wavelength laser such as a He—Cd laser (with a wavelength of 325 nm in a UV region) or an Ar laser (blue light with a wavelength of 488 nm or 514 nm) is used to expose the photoresist; there is no appropriate photoresist sensitive to long-wavelength light. Thus, increasing the wavelength is impractical.

### SUMMARY OF THE INVENTION

In view of the above problem, it is an object of the present invention to provide a method and an apparatus for producing a grating, which realize an oscillation wavelength different from the one determined by periods of the first and second gratings as well as overcome a problem of reducing an available grating area, and a DFB solid-state dye laser produced with the method and/or apparatus.

Hereafter, several modes of an invention, which are considered claimable (hereinafter referred to as “claimable invention”) in the subject application, will be presented and described. The modes of the invention are numbered like the appended claims and dependent on the other mode or modes, where appropriate, for easier understanding of the claimable invention. It is to be understood that the invention is not limited to the constituent elements or any combinations thereof which will be described in the following modes.

That is, the claimable invention shall be construed in the light of the following descriptions of the mode or modes and preferred embodiments of the invention. It is to be further understood that any mode in which one or more constituent elements is/are added to any one of the following modes and any mode in which one or more constituent elements is/are deleted from any one of the following modes may be considered claimable.

(1) A DFB solid-state dye laser element including: a laser medium containing an organic dye; and a distribution feedback-type resonance unit having a third grating including a Moire fringe corresponding to an overlap between first and second gratings formed in different directions.

According to the DFB solid-state dye laser element of this mode, the first and second gratings each having a specific period are formed, making it possible to produce a third grating having a period different from the periods of the first and second gratings.

(2) In the DFB solid-state dye laser element according to the mode (1), the period of the third grating is preferably longer than the periods of the first and second gratings.

According to the DFB solid-state dye laser element of this mode, the third grating having a long period can be produced with no special measures taken for extending the periods of the first and second gratings directly formed on the element.

(3) A DFB solid-state dye laser device including: the DFB solid-state dye laser element according to the mode (1); and an exciting unit for exciting the laser medium, wherein the DFB solid-state dye laser device oscillates a laser with an oscillation wavelength determined in accordance with the third grating.

According to the DFB solid-state dye laser device of this mode, a DFB solid-state dye laser device can be achieved with ease, which has an oscillation wavelength different from an oscillation wavelength determined on the basis of the periods of the first and second gratings directly formed on the element.

The DFB solid-state dye laser device of the mode (3) may further include an exit window, from which only laser light having an oscillation wavelength determined on the basis of a period of the third grating is picked up.

(4) In the DFB solid-state dye laser device of the mode (3), the oscillation wavelength determined on the basis of the period of the third grating is preferably within a near-infrared region. Here, the near-infrared region refers to a wavelength band of 1.3 to 1.5 μm, for example. The oscillation wavelength determined on the basis of the period of the third grating is a wavelength of m-th order diffracted light (m=1, 2, 3, . . . ), for example, second-order diffracted light.

(5) Further, in the DFB solid-state dye laser device of the mode (3), the periods of the first and second gratings are preferably determined such that a wavelength of diffracted light determined by the periods is preferably outside of a fluorescence spectrum range of the organic dye.

According to the DFB solid-state dye laser device of this mode, a laser can more efficiently oscillate due to the oscillation wavelength determined by the period of the third grating.

(6) Further, in the DFB solid-state dye laser device of the mode (3), the organic dye preferably has a fluorescence spectrum inclusive of a near-infrared region. The present invention imposes no particular limitations on the type of organic dye but specific examples of desirable ones include 3,3-Diethyl-9,11,15,17-dineopentylene-5,6,5′,6′-tetramethoxy-thiapentacarbocyanine perchlorate (laser oscillation wavelength region: 1200 to 1250 nm), Pentacarbocyanine derivative (laser oscillation wavelength region: 1250 to 1300 nm), LDS 925/Styryl 13 (available from Exciton Co., laser oscillation wavelength region: 902 to 1023 nm), IR-140 (available from Exciton Co., laser oscillation wavelength region: 906 to 1018 nm), LDS867 (available from Exciton Co., laser oscillation wavelength region: 922 to 963 nm), LDS950/Styryl 14 (available from Exciton Co., laser oscillation wavelength region: 928 to 1084 nm), and IR143 (available from Exciton Co., laser oscillation wavelength region: 894 to 1095 nm).

(7) A method of producing a grating with two-beam interference exposure, including: depositing a photoresist on a substrate; exposing the photoresist to two beams interfering with each other to record a first stripe pattern corresponding to a light and dark pattern of an interference fringe of the two beams; relatively rotating the substrate to change a position of the substrate and an array direction of the light and dark pattern of the interference fringe by a predetermined angle; exposing the photoresist to the two beams to record a second stripe pattern in a direction different from the array direction of the first stripe pattern; and removing an uncured portion of the photoresist to develop first and second gratings corresponding to the first and second stripe patterns, the predetermined angle being set to an angle at which a Moire fringe corresponding to an overlap between the first and second gratings is generated with a period equal to or longer than periods of the first and second gratings.

According to the production method of this mode, the first and second gratings each having a particular period are formed while adjusting an overlap angle, making it easy to produce a grating including a Moire fringe corresponding to an overlap between the first and second gratings and having a desired period.

(8) In the production method of the mode (7), the step of relatively rotating the substrate to change the position of the substrate and an array direction of the light and dark pattern of the interference fringe by a predetermined angle may be carried out such that the substrate is inclined at an angle α/2 (or −α/2) to a reference direction, and the substrate having the first stripe pattern formed thereon is rotated by a predetermined angle α and inclined at an angle −α/2 (or α/2) to the reference direction.

An organic dye-doped solid material such as acrylic or silica glass is applied onto the surface of the thus-prepared “photoresist grating” including the first and second gratings that generate a Moire fringe due to the overlap therebetween to thereby prepare a laser medium to produce a DFB solid-state dye laser.

(9) In the production method of the mode (7), the predetermined angle α satisfies the following relationship:

cos α≧(P₁/2P₂) (2)

where P₁ and P₂ represent periods of the first grating and second grating, respectively (P₁≧P₂).

(10) An apparatus for producing a grating applied to the production method according to the mode (7), including: a laser light source; a first rotating stage having a first supporting surface and a rotational axis substantially orthogonal to the first supporting surface; a second rotating stage placed on the first supporting surface and having a second supporting surface substantially vertical to the first supporting surface and a rotational axis substantially orthogonal to the second supporting surface; a reflecting unit placed on the first supporting surface and having a reflection surface that is substantially square to the second supporting surface; an optical system for shaping a beam from the laser light source and guiding the beam to the second supporting surface and the reflection surface; and a control unit for controlling rotations of the first rotating stage and the second rotating stage, wherein the substrate having the photoresist deposited thereon is placed on the second supporting surface, the two interfering beams include a beam directly guided to the second supporting surface and a beam guided to the reflection surface and reflected back to the second supporting surface, and rotation of the first rotating stage and rotation of the second rotating stage are independently controlled.

According to the production apparatus of this mode, it is possible to produce a grating including a Moire fringe corresponding to an overlap between the first and second gratings and having a desired period with ease on the basis of the production method according to the mode (7).

A preferred method of producing a grating through two-beam interference exposure with the production apparatus according to the mode (10) is given below.

(11) A method of producing a grating with two-beam interference exposure, including: placing a substrate having a photoresist deposited thereon on the second rotating stage; driving the first rotating stage to rotate the substrate up to an irradiation position where laser light from the laser light source is applied; driving the second rotating stage to change an angle of the substrate to a reference direction to a first angle; shaping a beam from the laser light source and guiding the beam to the second supporting surface and the reflection surface of the mirror to expose the photoresist to two interfering beams including a beam directly guided to the second supporting surface and a beam guided to the reflection surface and reflected back to the second supporting surface to record a first stripe pattern corresponding to a light and dark pattern of an interference fringe of the two beams; driving the second rotating stage to change an angle of the substrate to the reference direction to a second angle; and exposing the photoresist to the two beams to record a second stripe pattern in a different direction from the first stripe pattern.

According to the present invention, a grating is formed with a Moire fringe, making it possible to produce a grating having a period different from periods of gratings directly formed through two-beam interference exposure without changing a wavelength of laser light used in the two-beam interference exposure and an incident angle thereof. As a result, it is possible to produce a longer period grating with ease at low costs while ensuring a large area without largely changing existing equipment used for two-beam interference exposure. The DFB solid-state dye laser and the method and apparatus for producing the DFB solid-state dye laser according to the present invention are effective particularly for a DFB solid-state dye laser having a longer oscillation wavelength that covers a near-infrared region.

### BRIEF DESCRIPTION OF THE DRAWINGS

FIG. 1 is an explanatory view showing a structure of main portions of a DFB solid-state dye laser element and a DFB solid-state dye laser device according to an embodiment of the present invention;

FIG. 2 is an explanatory view showing a structure of a general Moire fringe;

FIG. 3 shows a basic unit for calculating a Moire fringe period;

FIG. 4 shows an SEM image of a Moire grating formed on a photoresist surface;

FIG. 5 shows an example of a narrowband laser oscillation spectrum produced with the DFB solid-state dye laser device according to an embodiment of the present invention;

FIG. 6 schematically shows a two-beam interference exposure system according to the present invention;

FIG. 7 shows a main portion of an apparatus for producing a Moire grating according to the present invention;

FIGS. 8A and 8B are enlarged views of a preferred mode of a rotating stage, a mirror, and a sample stage in an apparatus for producing a Moire grating according to the present invention;

FIGS. 9A to 9C are explanatory views schematically showing a process for forming a Moire fringe through two exposure steps;

FIG. 10 is a flowchart showing a procedure for applying laser light to photoresist-coated glass;

FIGS. 11A to 11E are explanatory views of a process for producing a DFB laser including a Moire grating formed on a substrate; and

FIGS. 12A and 12B show a relationship between an incident angle θ of laser light applied to a mirror and a substrate, and an area of a produced grating.

### DESCRIPTION OF THE PREFERRED EMBODIMENTS

Hereinafter, preferred embodiments of the present invention will be described with reference to the accompanying drawings.

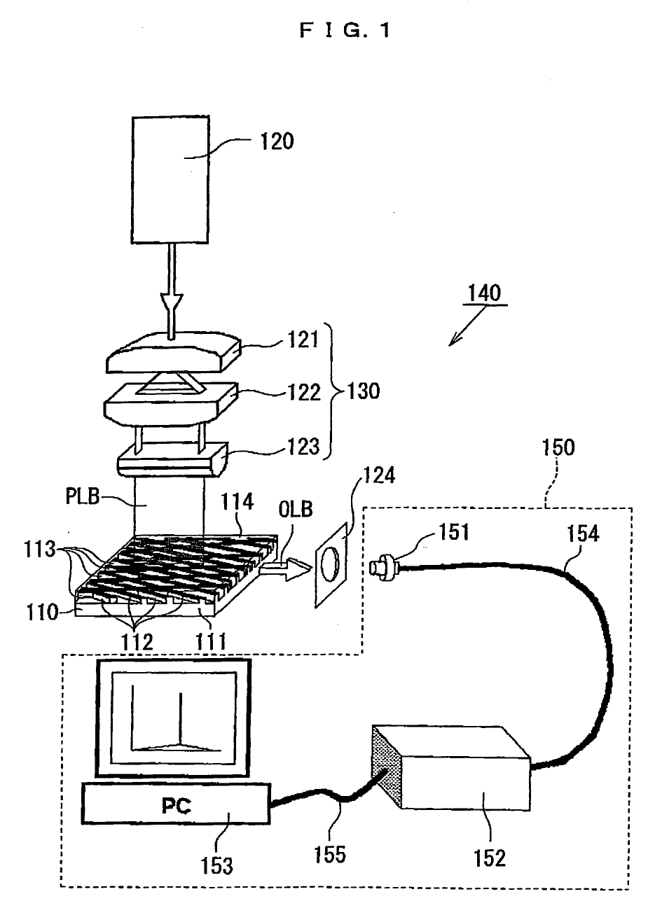

Referring to FIG. 1, a description is given of structures of a DFB solid-state dye laser element 110 and a DFB solid-state dye laser device 140 according to an embodiment of the present invention. In FIG. 1, a measurement system 150 for measuring a spectrum of output laser light is also illustrated.

In the DFB solid-state dye laser element 110 of this embodiment, a first grating 112 and a second grating 113, for example, photoresist gratings, are formed in different directions on a substrate 111 made of glass or the like, and the first and second gratings are coated with a laser medium 114 prepared by doping an organic dye into a solid material (for example, acrylic or silica glass). In addition, the DFB solid-state dye laser element 110 includes a third grating (Moire grating) based on a Moire fringe that is produced by the first grating 112 and the second grating 113 crossing each other. Its structure and operation are described in detail below.

The DFB solid-state dye laser device 140 of this embodiment includes the DFB solid-state dye laser element 110, an Nd:YAG laser light source 120 as an exciting unit of this embodiment, a lens system 130 for beam-shaping and guiding excitation light PLB from the laser light source 120, and an exit window 124, from which output laser light OLB is picked up. The DFB solid-state dye laser device 140 controls the excitation light PLB from the laser light source 120 using, for example, a beam attenuating filter (not shown) and allows the light to enter the lens system 130. The lens system 130 expands the incident excitation light PLB to a linear beam with a cylindrical lens 121, shapes the linear beam into parallel light with a cylindrical lens 122, and cuts off edge portions of the beam through an aperture or slit (not shown). Next, the parallel light is condensed in a vertical direction to the sheet and shaped into a thin linear beam with a cylindrical lens 123 that is placed at an angel of 90 degrees to the lenses 121 and 122. The thus-shaped excitation light PLB is applied to the DFB solid-state dye laser element 110. Then, the output laser light OLB is emitted from the DFB solid-state dye laser element 110 through the exit window 124. The exit window 124 is necessary particularly in the case of putting the DFB solid-state dye laser element 110 into a metal- or resin-made package; the window is provided in such a position as to emit light from a Moire fringe periodic direction to the outside of the package.

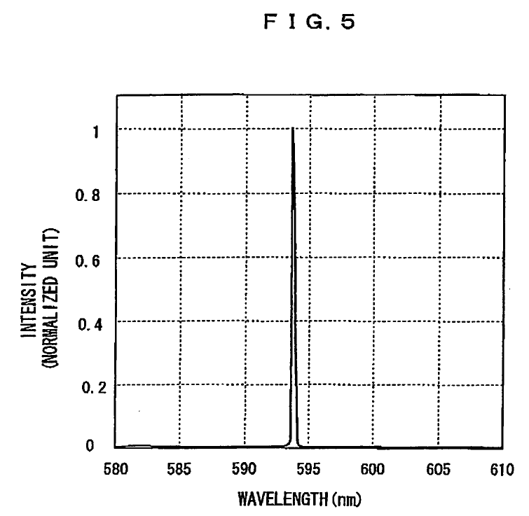

A spectrum of the output laser light OLB can be checked after the light is guided to a spectrograph 152 through an optical fiber 154 by way of a light input end 151, and its data is sent to a personal computer from the spectrograph 152 through a USB cable 155 or the like and processed as appropriate. FIG. 5 shows an example of the thus-obtained oscillation spectrum.

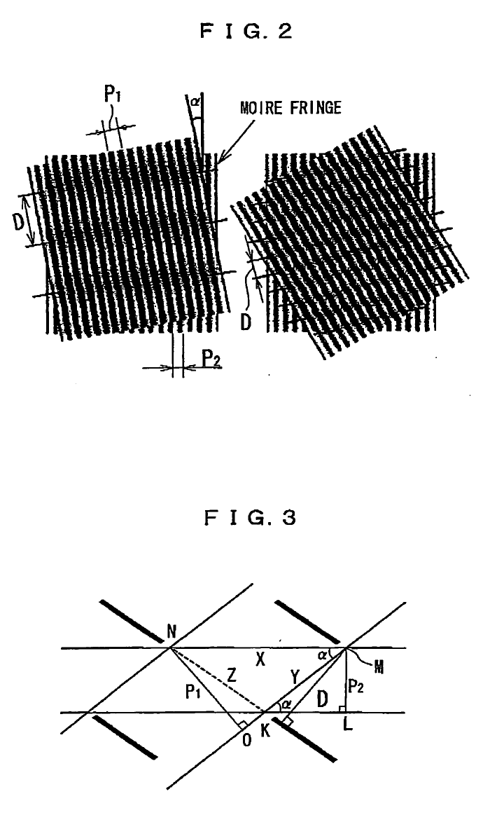

Next, a grating including a Moire fringe in the DFB solid-state dye laser element 110 is described. In general, as shown in FIG. 2, the Moire fringe is a stripe pattern that is formed by superimposing two periodic structures (having periods P₁ and P₂) on each other and has a unique period D different from the periods P₁ and P₂ of the superimposed periodic structures. The Moire fringe period D is changed in accordance with an angle α at which the two periodic structures overlap each other as shown in FIG. 2. A process of determining the Moire fringe period D is considered from a geometrical viewpoint and expressed mathematically.

FIG. 3 shows a basic unit of the Moire fringe. Two pairs of parallel lines arranged at intervals P₁ and P₂ define the periodic structures to be superimposed. The intervals P₁ and P₂ correspond to periods of the respective periodic structures. Further, the Moire fringe is indicated by the heavy line and a period of the Moire fringe is denoted by D. The angle α is the angle at which the original periodic structures overlap each other. Provided that X represents a length of a straight line MN and Y represents a length of a straight line KM, two right triangles KLM and NOM satisfy the following relationship.

X=P₁/sin α,Y=P₂/sin α (3)

In addition, the triangle KMN satisfies the following relationship on the basis of cosine law.

Z²=X²+Y²−2XY cos α (4)

Therefore, the following expression is established:

### [Expression 1]

Z=\sqrt{X²+Y²−2XY cos α} (5)

Further, if an area of the triangle KMN is given by two different expressions, the following expression is established.

Z·D/2=P₂·X/2 (6)

The Moire fringe period is expressed as follows:

D=P₂X/Z (7)

Substituting Expressions (3) and (4) into Expression (7) gives the following expression.

### [Expression 2]

$$D = \frac{{P}_{1} {P}_{2}}{\sqrt{{P}_{1}^{2} + {P}_{2}^{2} - 2 {P}_{1} {P}_{2} cos α}} \qquad ( 8 )$$

Thus, the Moire fringe period D can be determined on the basis of periods P₁ and P₂ of the periodic structures and the angle α at which the structures overlap with each other. In addition, the Moire fringe period D can be longer than the periods P₁ and P₂ of the original stripe patterns under the following condition:

cos α≧(P₁/2P₂) (9)

where P₁≧P₂

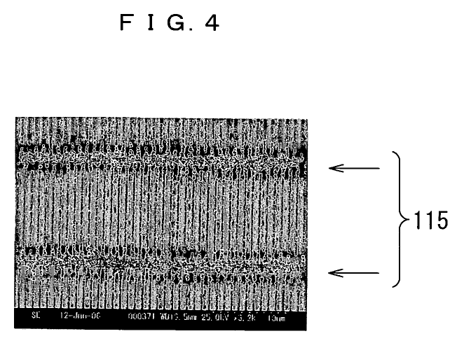

As understood from the above, a Moire grating can be produced such that the photoresist surface is at angle of α and two-beam interference exposure is carried out twice on the basis of the process of producing the photoresist grating. FIG. 4 shows a photograph of a Moire fringe actually formed on the photoresist surface, which is taken with a scanning electron microscope (SEM). Two stripe patterns 115 extending in a horizontal direction are Moire fringes. The present invention aims at laser oscillation with the Moire grating (third grating) 115 including such a Moire fringe.

The Moire grating becomes advantageous in that even if a grating with a long period Λ is produced, there is no need to be exposed with a small incident angle θ thus obtainable for the large area grating.

Next, the whole process for manufacturing a DFB laser according to the present invention is described.

(a) Applying a photoresist onto a substrate through spin-coating.
(b) Irradiating the photoresist with an Ar ion laser twice through two-beam interference exposure to produce first and second gratings, which differ from each other by an interference fringe inclination angle of α/2. As a result, a third grating (Moire grating) is obtained on the basis of Moire fringe that is produced by the first and second gratings crossing each other.
(c) Rinsing with distilled water.
(d) Coating the gratings with an organic dye (which oscillates with a wavelength corresponding to a Moire grating period but prohibited to oscillate with a wavelength corresponding to the periods of the first and second gratings).
(e) Irradiating the grating produced in (d) with excitation laser light as shown in FIG. 1 to obtain oscillation laser light.

A laser oscillation test was carried out in such a manner that the surface of the Moire grating, which is produced with a photoresist by the above method, is coated with acryl doped with Rhodamine B as one of the organic dyes to thereby produce a DFB solid-state dye laser. As a result, a narrowband laser oscillation spectrum is obtained as shown in FIG. 5. This result shows that the Moire fringe grating has sufficient diffraction efficiency for the DFB solid-state dye laser to oscillate.

Incidentally, the present invention is not particularly limited to the above-mentioned type of organic dye, but specific examples of desirable ones include 3,3-Diethyl-9,11,15,17-dineopentylene-5,6,5′,6′-tetramethoxy-thiapentacarbocyanine perchlorate (laser oscillation wavelength region: 1200 to 1250 nm), Pentacarbocyanine derivative (laser oscillation wavelength region: 1250 to 1300 nm), LDS 925/Styryl 13 (available from Exciton Co., laser oscillation wavelength region: 902 to 1023 nm), IR-140 (available from Exciton Co., laser oscillation wavelength region: 906 to 1018 nm), LDS867 (available from Exciton Co., laser oscillation wavelength region: 922 to 963 nm), LDS950/Styryl 14 (available from Exciton Co., laser oscillation wavelength region: 928 to 1084 nm), and IR143 (available from Exciton Co., laser oscillation wavelength region: 894 to 1095 nm).

In general, the oscillation wavelength of the DFB solid-state dye laser is given by the following expression:

λ=2nΛ/m (10)

where n represents a refractive index of the laser medium, m represents the order of diffraction, and Λ represents the grating period. Provided that the laser oscillation wavelength is a near-infrared wavelength, that is, λ=1.3 μm, m=2, and n=1.49 (under the condition that a laser medium is prepared by doping a dye into a silica xerogel), Λ=0.872 μm. To produce a Moire grating having such a period, the first and second gratings having periods P₁ and P₂ (P₁=P₂=0.5 λm) may be superimposed on each other at an angle α of 33.3°.

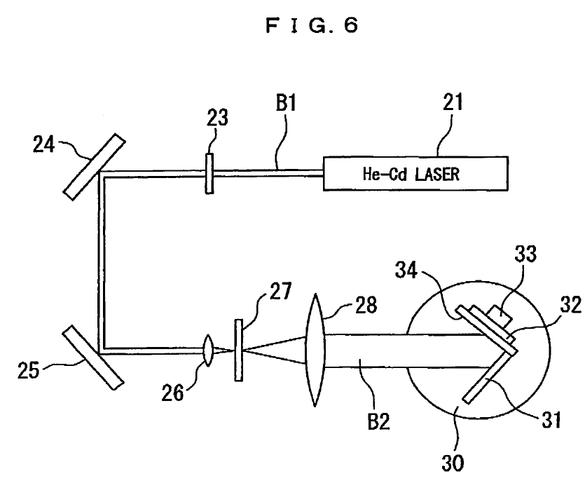

Referring next to FIGS. 6 to 10, a description is given of an apparatus and a method for producing a grating through two-beam interference exposure of the present invention.

FIG. 6 schematically shows a two-beam interference exposure system. A photoresist-coated glass (substrate) is placed on a sample stage 34 on a rotating stage 30. Here, the sample stage 34 is set at right angles to an aluminum mirror 31. A beam B1 emitted from a He—Cd laser 21 reaches the glass on the sample stage 34 through beam-guiding and beam-shaping optical systems 23 to 28. That is, the beam B1 is transmitted through a shutter 23 and then reflected by aluminum mirrors 24 and 25, followed by beam-shaping into a parallel beam B2 having a diameter of several cm. The beam B2 is applied to the glass on the sample stage 34. At this time, a portion of the beam B2 directly reaches the photoresist while the remaining part of the beam is reflected by the aluminum mirror 31 and then reaches the photoresist on the glass. The two beams cause two-beam interference and the resultant light and dark patterns (stripe patterns) are recorded on a photoresist film.

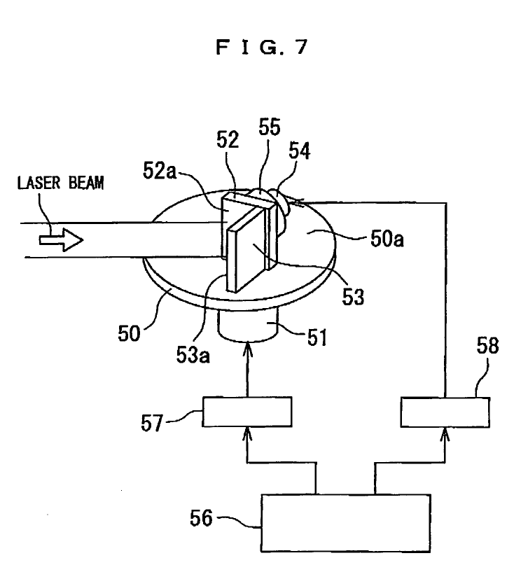

FIG. 7 is a diagram of an apparatus producing a Moire grating and coincidentally indicates a control block diagram, which controls a motor 51 and a motor 54 driving a rotating stage A (the first rotating stage) 50 and a rotating stage B (the second rotating stage) 55 respectively. Here, the rotating stage A (50) and the rotating stage B (52) are in a position equivalent with the rotating stages 30 and 32 shown in FIG. 6. A motor 51 for controlling rotation is provided below the rotating stage A 50, and the stage A 50 has a supporting surface (first supporting surface) 50a as a flat upper surface orthogonal to the rotational axis (motor shaft) of the motor 51. A mirror (reflecting unit) 53 having a reflection surface 53a on at least one side and a rotating stage B (second rotating stage) 55 provided with a motor 54 are arranged on the supporting surface 50a. A sample stage 52 is placed on the rotating stage B 55, which has a supporting surface 52a (second supporting surface) as a flat surface orthogonal to the rotating axis of the motor 54. The photoresist-coated glass is placed on the supporting surface 52a of the sample stage 52. Further, the mirror 53 and the sample stage 52 are arranged vertically with respect to the supporting surface 50a of the rotating stage A 50 with the supporting surface 52a being square to the reflection surface 53a. A control circuit (control unit) 56 for controlling rotation of the rotating stage A 50 and the rotating stage B 55 is, for example, a microprocessor, which independently controls the motors 51 and 54 through drivers 57 and 58.

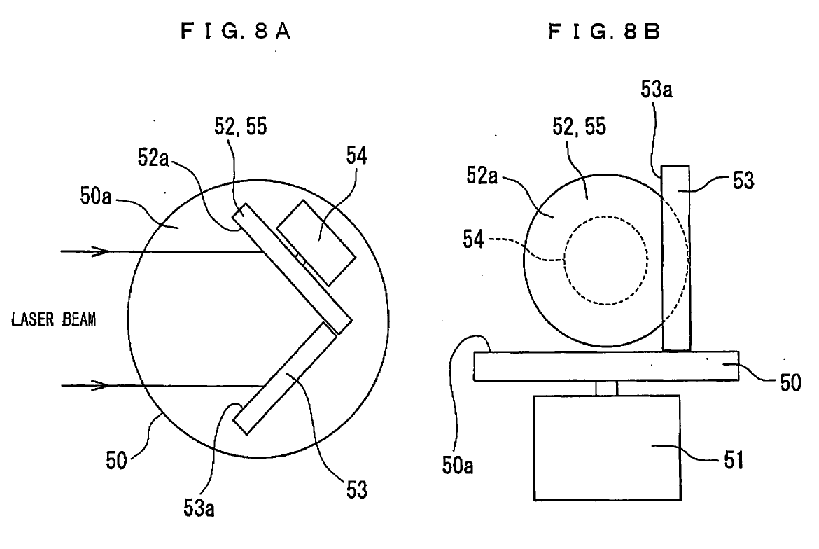

Incidentally, the sample stage 52 is placed with some interval from the supporting surface 50a of the rotating stage A 50 in a parallel direction to the sheet so as to rotate about the rotational axis of the rotating stage B 55. As shown in FIG. 8, in order to freely rotate the sample stage 52, the stage may be formed into a disk-like shape integrally with the disk-like rotating stage B 55, or a disk-like sample stage prepared independently of the rotating stage B 55 may be arranged coaxially with the rotating stage B 55.

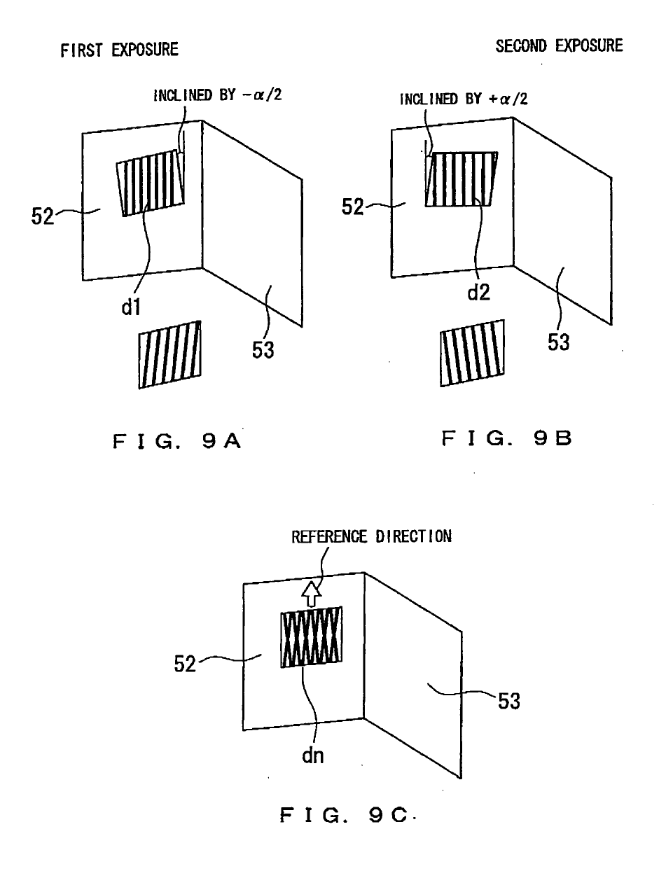

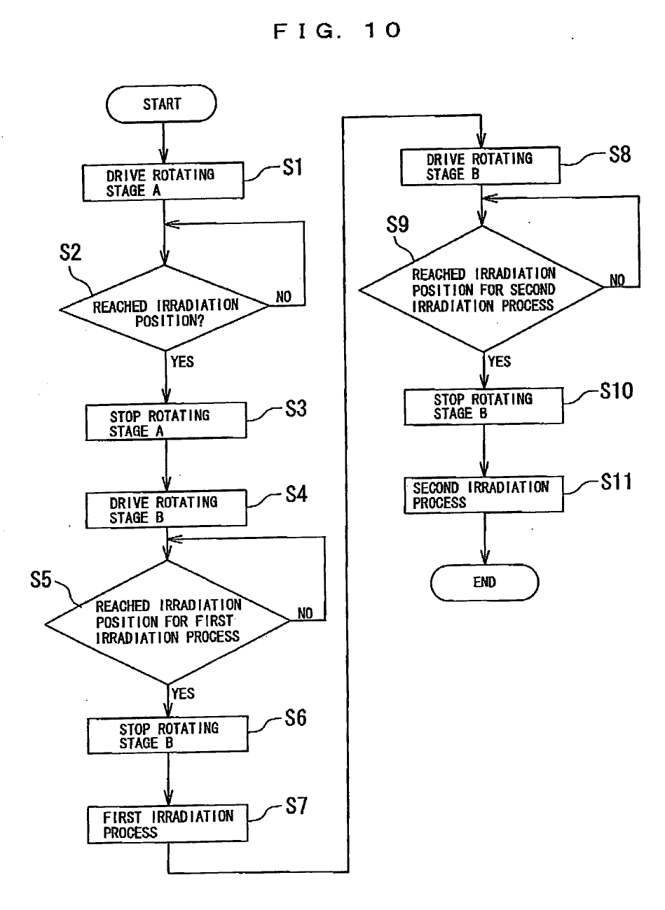

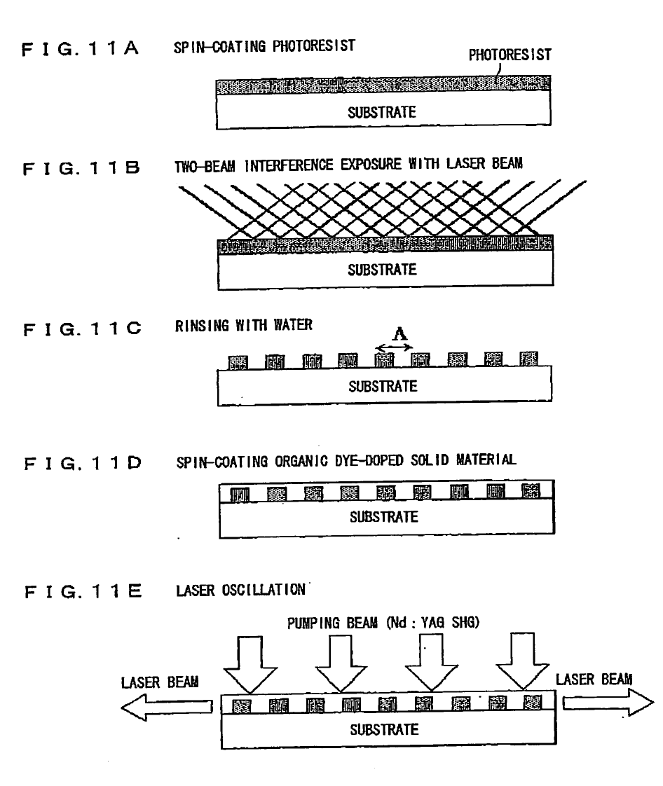

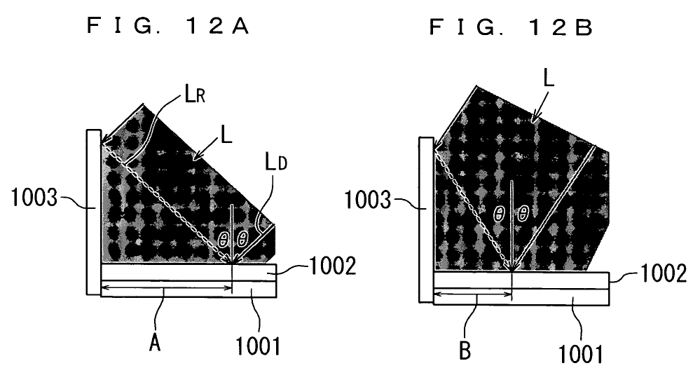

The two-beam interference exposure is carried out twice by the production apparatus with the angle α. Referring to FIGS. 9A to 9C, this process is described below in brief. In FIGS. 9A to 9C, the mirror 53 and the sample stage 52 are only illustrated. FIG. 9A shows the first exposure executed under the condition that the photoresist-coated glass is exposed to a beam with the sample stage 52 being inclined at the beam angle (−α/2) with respect to a vertical direction (reference direction indicated by the arrow of FIG. 9C) at a reference position. The second exposure is executed under the condition that the motor 54 is driven and the sample stage 52 is inclined at the angle (+α/2) with respect to the reference direction (FIG. 9B). As a result of the two exposure processes, light and dark patterns of an interference fringe formed by the first and second exposure processes are superimposed on top of each other and recorded to the photoresist on the glass. The superimposed patterns produce a Moire fringe. In this case, the period direction of the Moire fringe is parallel to the reference direction.

Referring to FIG. 10, a procedure for applying laser light to photoresist-coated glass placed on the sample stage 52 is described below.

In FIG. 10, the driver 57 rotates the motor 51 to drive the rotating stage A 50 in step S1, and it is determined whether or not the rotating stage A 50 reaches a predetermined laser light irradiation position (step S2). If the determination result is negative, the stage is further rotated up to the laser light irradiation portion. If the determination result is positive, the procedure advances to step S3, the rotating stage A 50 is stopped. Next, the rotating stage B 55 is rotated by the driver 58 (step S4), and it is determined whether or not the stage reaches a first laser light irradiation position (for example, a position shifted from the original position by an angle of −α/2 with respect to the reference direction). If not reached, the stage is further rotated. If reached, the rotating stage B 55 is stopped (step S6) and subjected to a first laser light irradiation process to record first stripe patterns corresponding to light and dark patterns of an interference fringe formed through the two-beam interference exposure, onto the photoresist (step S7).

Next, the rotating stage B 55 is rotated again and it is determined whether or not the stage reaches a second laser light irradiation position (for example, a position changed by the angle of +α/2 with respect to the reference direction). If not reached, the stage is further rotated. If reached, the rotating stage B 55 is stopped (step S10) and subjected to a second laser light irradiation process to record second stripe patterns corresponding to light and dark patterns of an interference fringe formed through the two-beam interference exposure, onto the photoresist (step S11). The thus-prepared glass is rinsed to thereby form a physical grating.

A grating is coated with a laser medium and then sliced into cubes measuring about 5 mm per side for mass-production of laser elements. According to the present invention, a large-area grating can be produced through one process, and a number of laser elements can be obtained in one step, so laser elements can be manufactured at a low cost.

What is claimed is:

1. A DFB solid-state dye laser element comprising:
a laser medium containing an organic dye; and
a distribution feedback type resonance unit having a third grating including a Moire fringe corresponding to an overlap between first and second gratings formed in different directions.

2. A DFB solid-state dye laser device according to claim 1 comprising:
the DFB solid-state dye laser element; and
an exciting unit for exiting the laser medium,
wherein the DFB solid-state dye laser device oscillates a laser with an oscillation wavelength determined in accordance with the third grating.

3. A method of producing a grating with two-beam interference exposure, comprising the steps of:
depositing a photoresist on a substrate;
exposing the photoresist to two beams interfering with each other to record a first stripe pattern corresponding to a light and dark pattern of an interference fringe of the two beams;
relatively rotating the substrate and an array direction of the light and dark pattern of the interference fringe by a predetermined angle;
exposing the photoresist to the two beams to record a second stripe pattern in a direction different from the array direction of the first stripe pattern; and
removing an uncured portion of the photoresist to develop first and second gratings corresponding to the first and second stripe patterns, wherein
the predetermined angle is set to an angle at which a Moire fringe corresponding to an overlap between the first and second gratings is formed with a period equal to or longer than periods of the first and second gratings.

4. An apparatus for producing a grating by using the production method according to claim 3, comprising:
a laser light source;
a first rotating stage having a first supporting surface and a rotational axis substantially orthogonal to the first supporting surface;
a second rotating stage placed on the first supporting surface and having a second supporting surface substantially vertical to the first supporting surface and a rotational axis substantially orthogonal to the second supporting surface;
a reflecting unit placed on the first supporting surface and having a reflection surface that is substantially square to the second supporting surface;
an optical system for shaping a beam from the laser light source and guiding the beam to the second supporting surface and the reflection surface; and
a control unit for controlling rotations of the first rotating stage and the second rotating stage,
wherein the substrate having the photoresist deposited thereon is placed on the second supporting surface, the two interfering beams include a beam directly guided to the second supporting surface and a beam guided to the reflection surface and reflected back to the second supporting surface, and rotation of the first rotating stage and rotation of the second rotating stage are independently controlled.
